(19) United States
(12) Patent Application Publication
(10) Pub. No.: US 2025/0303327 A1
(43) Pub. Date: Oct. 2, 2025

(54) STRAINER

(71) Applicant: Systems Plant Services, Inc., El Dorado, AR (US)

(72) Inventors: Lee Pendleton MORGAN, Jonesboro, AR (US); Michael Roy WHITE, Crossett, AR (US)

(21) Appl. No.: 18/619,085

(22) Filed: Mar. 27, 2024

(51) Int. Cl. B01D 29/11; B01D 29/54

(52) U.S. Cl. CPC B01D 29/117; B01D 29/54; B01D 2201/0461; B01D 2201/347

(57) ABSTRACT

Embodiments herein describe a fluid strainer that includes a body and a lid. The inner surfaces of walls of the body and lid define a cavity therein. The body wall has a fluid inlet opening and a fluid outlet opening. A tube sheet disposed within the cavity divides the cavity into first and second chambers. The tube sheet has a plurality of filter openings and a fluid inlet. The fluid inlet is open to the first chamber. A plurality of filter retaining baskets are disposed in respective ones of the filter openings. A plurality of filter retainers are provided, each of which is configured to removably attach to the tube sheet and extend into a respective one of the filter retaining baskets. An internal fluid inlet pipe is disposed within the second chamber and couples the fluid inlet opening to the fluid inlet opening of the tube sheet.

### TECHNICAL FIELD

Examples of the present disclosure generally relate to a strainer suitable for filtering fluids such as water in industrial applications.

### BACKGROUND

Many industrial facilities utilize water as a process or working fluid. In many of these facilities, water is filtered to remove large particulates for the protection of downstream equipment and/or processes in which the water is utilized. At industrial facilities that have large scale water use applications, conventional water straining equipment generally does not have sufficient capacity to effectively filter water flowing in excess of 4000 gallons per minute. When filtration equipment is used above its rated capacity, leakage and inadequate filtering of fluids passing through the filtration equipment may occur, which may result in damage to downstream equipment, loss of product quality control and/or diminished productivity.

Thus, there is a need for an improved strainer suitable for high flow industrial applications.

### SUMMARY

Embodiments herein describe a fluid strainer that includes a body and a lid. The inner surfaces of walls of the body and lid defining a cavity therein. The wall of the body has a fluid inlet opening and a fluid outlet opening. The fluid strainer includes a tube sheet disposed within the cavity. The tube sheet divides the cavity into first and second chambers. The tube sheet has a plurality of filter openings and a fluid inlet. The fluid inlet is open to the first chamber A plurality of filter retaining baskets are provided, a respective one of which is disposed in a respective one of the filter openings. A plurality of filter retainers are provided, each of which are configured to removably attach to the tube sheet and extend into a respective one of the filter retaining baskets. An internal fluid inlet pipe is disposed within the second chamber and couples the fluid inlet opening to the fluid inlet opening of the tube sheet.

In other examples, the fluid outlet opening does not have filter retaining basket directly adjacent the fluid outlet opening.

In other examples, the plurality of filter openings are arranged in two concentric rows. An inner row of the two concentric rows have filter openings that are equally spaced, while an outer row of the two concentric rows have filter openings that are arranged in a C-shaped pattern.

In other examples, two concentric seals are provided that each sealingly contacting the lid and the body. In some examples, the concentric seals each have four lobes for improved sealing.

In other examples, the filter retainer comprises a spring wire form. The filter retainer may include a first end coupled to a first cross member section, the first cross member section coupled to a first clamp member section; a second end coupled to a second cross member section, the second cross member section coupled to a second clamp member section, the second clamp member section dispose parallel to the first clamp member section; and a connecting section coupling the first and second clamp member sections. The filter retainer has sufficient spring force to urge the first and second clamp member sections against opposite sides of the filter retaining basket.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 is a sectional schematic illustration of a strainer, according to an embodiment.

FIG. 2 illustrates a top view of the strainer with the lid remove allowing a tube sheet disposed within the body of the strainer to be viewed.

FIG. 3 illustrates a side view of a filter basket of the strainer, according to an embodiment.

FIG. 4 illustrates a partial sectional view of the tube sheet illustrating a bag filter retained in the filter basket, according to an embodiment.

FIG. 5 illustrates a lip having multiple channels for accepting seal rings, according to an embodiment.

FIG. 6 illustrates seal rings compressed between a lid and a body of the strainer, according to an embodiment.

FIG. 7 is a top perspective view of the strainer of FIG. 1.

FIG. 8 is a side-view of the strainer of FIG. 1.

FIG. 9 is a top perspective view of the strainer of FIG. 1 illustrating the lid rotated clear of the body to allow access to the bag filters and tube sheet.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the features or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Embodiments herein describe a fluid strainer that is sturdy, dependable, securely-sealed, and relatively easy and inexpensive to maintain. The fluid strainer is suitable for high flow applications, that is, suitable for filtering fluid in excess of 4000 gallons per hour. In some example, the fluid strainer is advantageously configured with redundant seals between the lid and chamber body. Each of the seals may include a plurality of sealing points to both the lid and chamber body, thus significantly reducing potential leakage, even at pressures up to 150 pound per square inch of internal pressure. Moreover, the highly functional design accommodates up to 28 bags filter providing in excess of 110 square feet of filter media, thus reducing pressure drop across the strainer for more economical operation and extended service time between filter change outs.

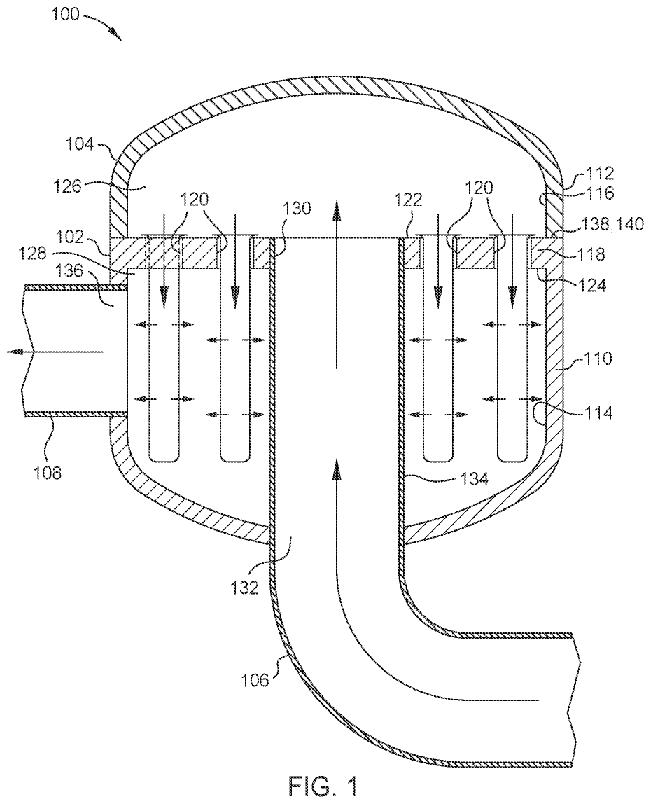

Turning now to FIG. 1, a schematic side view of a fluid strainer 100 is provided, according to an embodiment. The fluid strainer 100 may be used to filter fluids such as, without limitation, water. The fluid strainer 100 may be useful in one or more of a variety of applications including, without limitation, as a fluid (e.g., water) strainer for spray-cooled equipment, caster spraying systems, water descaling systems, heat exchanger systems, food and beverage operations, and fire suppression systems, among many other applications. In an example, the fluid strainer 100 may be used as a water filter for steel mill applications, such as a furnace spray cooling systems.

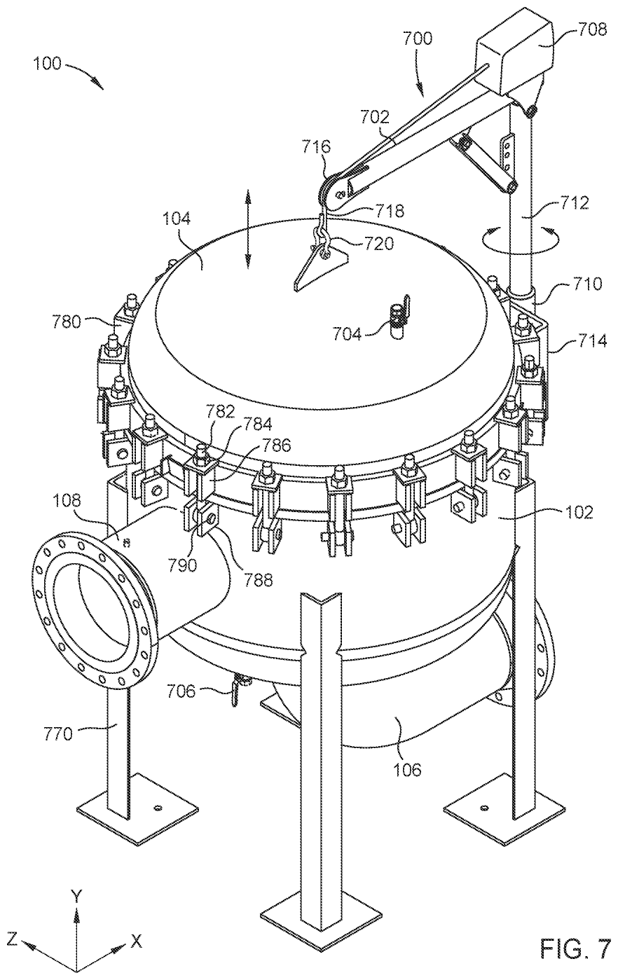

As illustrated in FIG. 1, the fluid strainer 100 includes a chamber body 102, a lid 104, a fluid inlet pipe 106, and a fluid outlet pipe 108. The body 102 includes a wall 110, and the lid 104 includes a wall 112. Internal surfaces 114 and 116 of walls 110 and 112 define an internal cavity of the fluid strainer 100. In one example, the internal surfaces 114 and 116 of walls 110 and 112 are cylindrical, while the center portion of the lid 104 and bottom center portion of the body 102 have a dome shape. The lid 104 may be removed from the body 102 to allow access to the internal cavity of the fluid strainer 100. In example, the lid 104 is secured to the body 102 using a plurality of dogs (later shown in FIG. 7) located around the circumference of the body to lid interface.

The chamber body 102 of the fluid strainer 100 further includes a tube sheet 118. The tube sheet 118 is generally a planar sheet of steel or other rigid material that splits the internal cavity of the fluid strainer 100. The tube sheet 118 extends across the internal surface 114 of the side wall 110. The tube sheet 118 is sealingly coupled to the side wall 110, for example, by welding. The tube sheet 118 welded to the inner wall 114 of the side wall 110, or the tube sheet 118 may be welded on top of the side wall 110.

A first surface 122 of the tube sheet 118 faces the lid 104, and when the lid 104 is disposed on the body 102, forms a lower boundary of an upper chamber 126 defined between the lid 104 and the tube sheet 118. A second surface 124 of the tube sheet 118 faces away from the lid 104 towards a bottom of the body 102. The second surface 124 of the tube sheet 118 forms an upper boundary of a lower chamber 128 defined between the side walls 110 and bottom surface of the body 102 and the second surface 124 of the tube sheet 118.

The tube sheet 118 includes a plurality of filter openings 120 that extend between the first and second opposing surfaces, 122 and 124, of tube sheet 118. The plurality of filter openings 120 provide a passage between the upper and lower chambers 126 and 128 through the tube sheet 118. The filter openings 120 are dimensioned to receive respective strainers, examples of which are provided further below. In the example of FIG. 1, tube sheet 118 serves as, or defines a boundary between first and second (e.g., upper and lower) chambers 126 and 128.

The tube sheet 118 further has a fluid inlet opening 130 that extends between first and second surfaces 122 and 124 (i.e., that connects upper and lower chambers 126 and 128). The fluid strainer 100 further has a fluid inlet opening 132 through wall 112 of body 102, and an internal fluid inlet pipe 134 that extends from fluid inlet opening 132 of wall 110 to fluid inlet opening 130 of tube sheet 118. In this example, unfiltered fluid flows from external fluid inlet pipe 106, through internal fluid inlet pipe 134 and fluid inlet opening 130, into upper chamber 126. From upper chamber 126, fluid flows through filter openings 120 (and filters secured therein) into the lower chamber 128. From the lower chamber 128, the filtered fluid flows through a fluid outlet opening 136 of wall 110, to fluid outlet pipe 108. In another example, internal fluid inlet pipe 134 may be omitted, and fluid inlet opening 132 may be provided above tube sheet 118 to provide fluid from external fluid inlet pipe 106 directly into upper chamber 126. The example depicted in FIG. 1, having the fluid inlet opening 132 formed through the wall 110 of the body 102 and having the internal fluid inlet pipe 134 pass through lower chamber 128 allows the lid 104 to be easily removed as the lid 104 is not connected to any of the inlet or outlet piping.

The body 102 and the tube sheet 118 are designed to limit fluid flow between upper and lower chambers 126 and 128 only through filter openings 120. In an example, an entire perimeter of tube sheet 118 is in sealing contact with sidewall 110 of the body 102, such that fluid flow between upper and lower chambers 126 and 128 is constrained/restricted to filter openings 120. The tube sheet 118 may be fabricated as an integral part of body 102, or may be fabricated separately and attached to internal surface 114 (e.g., by welding, bolts or other technique), rest upon a ledge extending inwardly from internal surface 114 of the body 102, or be attached to the top surface of the side wall 110 of the body 102.

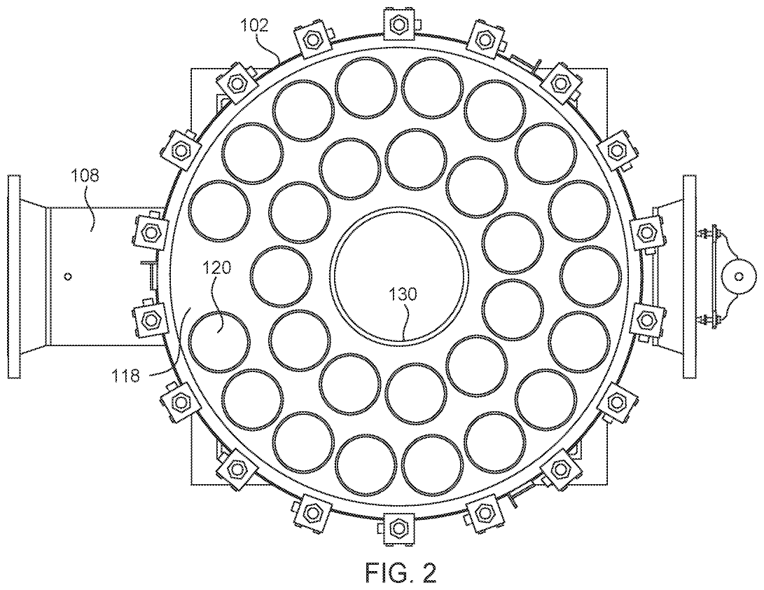

FIG. 2 illustrates a top view of the body 102 and the tube sheet 118, according to an embodiment. In the example of FIG. 2, the filter openings 120 have a circular cross-section. In other examples, the filter openings 120 may have oblong or polygon cross-sections. Further in the example of FIG. 2, the fluid inlet opening 130 is illustrated as co-axially located with the centerline of the tube sheet 118, and the filter openings 120 are positioned in a plurality of concentric circles centered around the centerline of the tube sheet 118. The centerline of the tube sheet 118 is also the centerline of the body 102. Positioning fluid inlet open in a central region of tube sheet 118 may serve to provide uniform distribution of fluid to the filter openings 120. The fluid inlet opening 130 is not, however, limited to the central region of tube sheet 118.

In one example, there are 28 filter openings 120 formed through the tube sheet 118. A radially inner circular row of filter openings 120 are equally spaced around the fluid inlet opening 130. A radially outer circular row of filter openings 120 are arranged in a “C” shape on common radius relative to the fluid inlet opening 130, with no filter opening 120 being formed directly in front of the fluid outlet pipe 108. The open space in front of the fluid outlet pipe 108 allows fluid to flow more freely, and with less pressure drop, into the fluid outlet pipe 108.

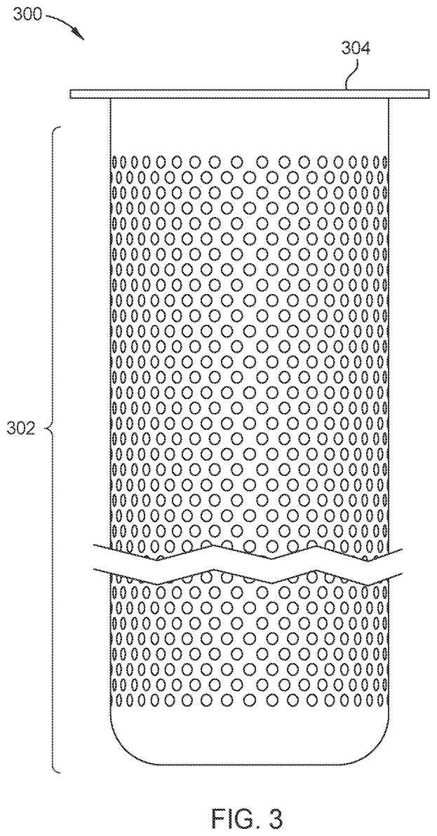

FIG. 3 illustrates a filter retaining basket 300, according to an embodiment. In FIG. 3, the filter retaining basket 300 includes a basket 302 and a lip 304. Basket 302 may dimensioned to fit/slide through the filter opening 120, while the lip 304 extends outward from the basket 302. In an example, the lip 304 is dimensioned to preclude lip 304 from passing through filter openings 120. In an example, where contours of filter openings 120 and lip 304 are circular, an outer diameter of lip 304 may be greater than a diameter of filter openings 120. The filter retaining basket 300 may be retained within a filter opening 120 by gravity or may be fastened or clamped to the tube sheet 118. Alternatively, or additionally, fluid strainer 100 may further include a filter retainer that retains filter retaining basket 300 in place. The basket 302 is generally perforated, formed from a wire mesh or is otherwise permeable to water. As later illustrated, a bag filter is disposed in the filter retaining basket 300. Fluid present in the upper chamber 126 enters the bag filter disposed in the filter retaining basket 300, and exits the bag filter through the perforations of the basket 302 and into the lower chamber 128, and ultimately out of the strainer 100 through the fluid outlet pipe 108.

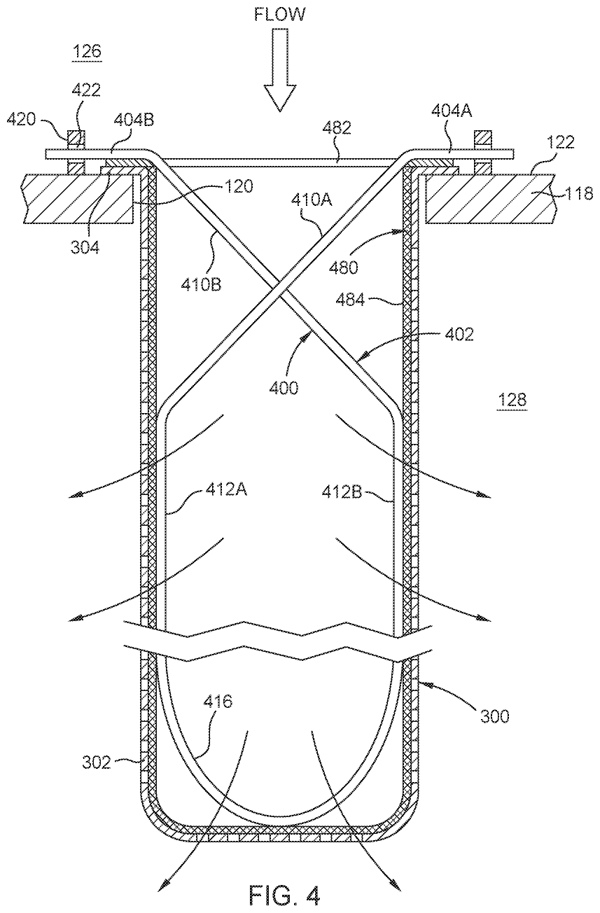

A filter retainer may be useful to prevent the bag filter from inadvertently sliding upwardly (towards the upper chamber 126) and out of the filter retaining basket 300 in the event of reverse fluid flow within the fluid strainer 100, such as which might occur during the initial filling of fluid strainer 100. Example filter retainers and bag filter are described below with reference to FIG. 4.

FIG. 4 illustrates a partial cross sectional view of the tube sheet 119 through one of the filter openings 120, illustrating the filter retaining basket 300 and bag filter 480 extending through the filter opening 120. In FIG. 4, the lip 304 of the filter retaining basket 300 is disposed on the upper surface 122 of the tube sheet 118, while the basket 302 extends through the filter opening 120 of the tube sheet 118 into the lower chamber 128 of the strainer 100. The bag filter 480 includes a header 482 attached to a filter bag 484. The filter bag 484 is fabricated from cellulose, polyester or other type of particular filtration media. The header 482 of the bag filter 480 is disposed on the lip 304 of the filter retaining basket 300, while the filter bag 484 extends into the filter retaining basket 300. A filter retainer 400 extends into the filter bag 484 and is secured to a retainer 420 mounted to the tube sheet 118 The filter retainer 400 prevents the filter bag 484 from inverting and extending back out of the filter opening 120 and into the upper chamber 126, for example if flow is temporarily revised to flow from the lower chamber 128 to the upper chamber 126. During normal operations, fluid flow into the bag filter 480 presses the filter bag 484 against the basket 302 of the strainer 100, thus proving mechanical support enabling the bag filter 480 to be used at high flow rates.

The filter retainer 400 is generally a wire form having sufficient resiliency and spring force to allow mounting ends 404A, 404B to be engaged and disengaged from a wire retainer 420. The mounting ends 404A, 404B are connected to a body portion 402. The mounting ends 404A, 404B, when the filter retainer 400 is installed, have an orientation generally parallel to the plane of the top surface 122 of the tube sheet 118. The body portion 402 may have a length substantially equal to a depth of filter basket 304. The body portion 402 may have shape or contour that holds opposite sides of the filter bag 484 against the sidewall of filter basket 304.

The body portion 402 includes cross member sections 410A, 410B, clamp member sections 412A, 412B, and a connecting section 416. The cross member section 410A terminates at one side at the end 404A and at the other side at the clamp member section 412A. The cross member section 410A may be substantially linear. The cross member section 410A is generally oriented at an obtuse angle relative to the end 404A. The cross member section 410A is also generally oriented at an obtuse angle with the clamp member section 412A. The clamp member section 412A is generally oriented at a right angle relative to the end 404A.

Similarly, the cross member section 410B terminates at one side at the end 404B and at the other side at the clamp member section 412B. The cross member section 410B may be substantially linear. The cross member section 410B is generally oriented at an obtuse angle relative to the end 404B. The cross member section 410B is also generally oriented at an obtuse angle with the clamp member section 412B. The clamp member section 412B is generally oriented at a right angle relative to the end 404B. The clamp member section 412B is generally parallel to the clamp member section 412A.

The connecting section 416 connects the clamp member sections 412A, 412B. In one example, the connecting section 416 has a full radius.

The wire retainers 420 are mounted to the top surface 122 of the tube sheet 118. In one example, the wire retainers 420 are disposed about 180 degrees apart on opposite sides of the filter opening 120. The wire retainers 420 are generally configured to releasably retain the ends 404A, 404B of the filter retainer 400. For example, the wire retainers 420 may be a clamp, pawl latch, fastener, magnet, eye strap, hook or other suitable device. In the example, depicted in FIG. 4, the wire retainers 420 are a block of metal, welded to the tube sheet 118, having cross holes 422 axially oriented towards a centerline of the filter opening 120. In one example, the wire retainer 420 is a nut.

Referring back to FIG. 1, a top surface 138 of the body 102 (or tube sheet 118) contacts lip 140 of the lid 104 when the lid 104 closes the fluid strainer 100. One or both of the top surface 138 of body 102 (or tube sheet 118) and/or lip 140 of the lid 104 may have one more seal glands dimensioned to receive one or more respective sealing rings, such as described below, to prevent leakage from the upper chamber 126 during operation of the strainer 100.

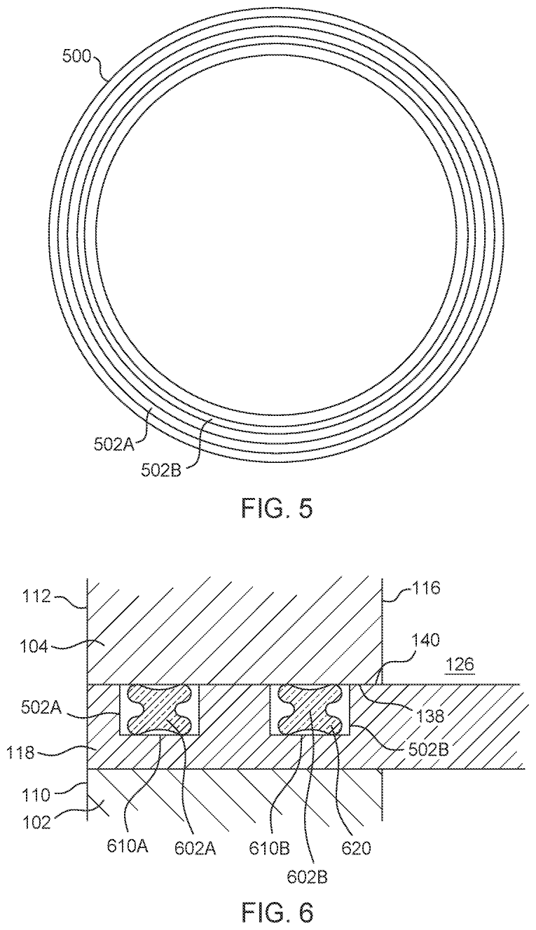

FIG. 5 illustrates a surface 500 of one or both of the top surface 138, lip 140 that is configured to accept sealing rings that seal the lid 104 to the body 102. In the example of FIG. 5, the lip 500 has multiple seal glands, illustrated as seal glands 502 and 504. The seal glands 602 and 604 are dimensioned to receive a respective sealing ring. The seal rings may be polygonal gaskets, O-rings, cup seals, lip seals, multi-lobed seals or other type of seal.

FIG. 6 illustrates two seal rings 602A, 602B providing a seal between the lid 104 and body 102. In FIG. 6, the seal glands 602, 604 are both shown formed in the lip 138 of the body 102. However, the seal glands 602, 604 may alternatively be both formed in the lip 140 of the lid 104, or partially in both of the lips 138, 140 of the body 102 and lid 140. In FIG. 6 the seal rings 602A, 602B are multi-lobed seals, shown illustratively with 4 lobes 620. Advantageously, the 4 lobes 620 provides each seal 602A, 602B with two sealing contact points with the bottom lip 140 of the lid 102 and two sealing contact points with a bottom surface 610A, 610B of the seal glands 602, 604. Thus, two seal rings 602A, 602B provide 8 redundant seals between the lid 104 and the body 102, thus making leakage between the lid 104 and the body 102 highly unlikely.

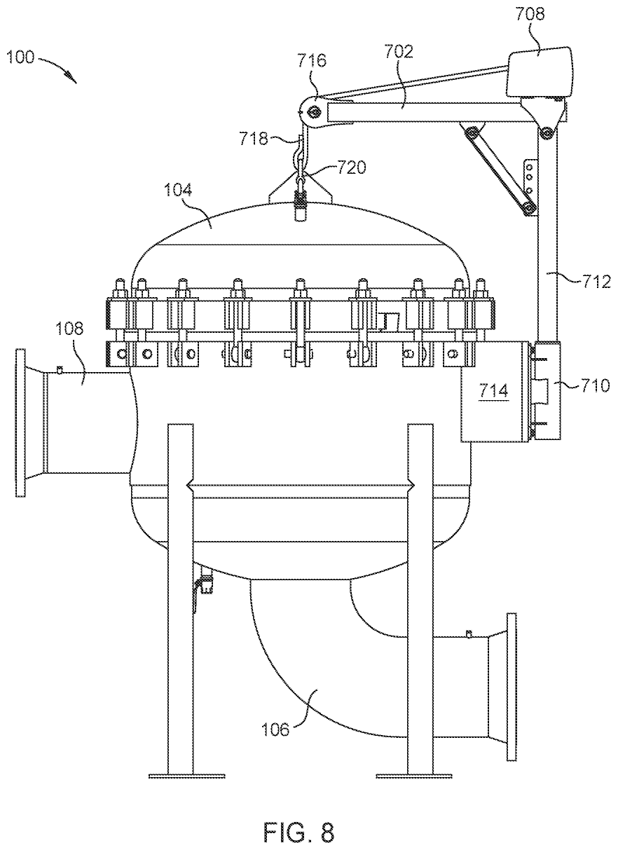

FIGS. 7 and 8 are perspective and side views of the fluid strainer 100 first illustrated in FIG. 1. The fluid strainer 100 further includes a crane 700, a pressure release valve 704, and a drain valve 706. The pressure release valve 704 is coupled to the lid 104 and generally includes a regulator that releases pressure from inside the upper chamber 126 when pressures exceed a predefined amount. In one example, the pressure release valve 704 is set to allow working pressures within the upper chamber 126 of the fluid strainer 100 to be in excess of 120 psi, such as up to 150 psi.

The drain valve 706 is generally connected to the body 102. The drain valve 706 allows the lower chamber 128 to be substantially emptied of fluid to allow service.

The fluid strainer 100 also includes a plurality of legs 770 that enable the fluid strainer 100 to be free standing during shipping and/or after installation.

As mentioned above, the lid 104 is removably coupled to the body 102 by a plurality of dogs 780. The dogs 780 may be any suitable clamp, latch, fastener or device suitable for securing the lid 104 to the body 102 while operating the strainer 100 at target pressures, which in one example is at pressures up to 150 psi. In the example depicted in FIG. 7, each dog 780 includes a threaded rod 782 pivotally coupled to a bracket 788 by a pivot pin 790. The bracket 788 is coupled to the body 102. The threaded rod 782 may be rotated to a substantially vertical position (in the Y direction) to engage a bracket 786 coupled to the lid 104. A nut 784 may be threaded onto the rod 782 to engage the bracket 786, which urges the lid 104 against the body 102, thus comprising the seals 602A, 602B. With the nut 784 sufficiently loosened to allow the rod 782 to disengage the bracket 786, the rod 782 may be rotated away from the lid 104 and clear of the bracket 786, allowing the lid 104 to be freely removed from the body 102 and allow access to the upper chamber 126 such that the bag filters 400 may be replaced.

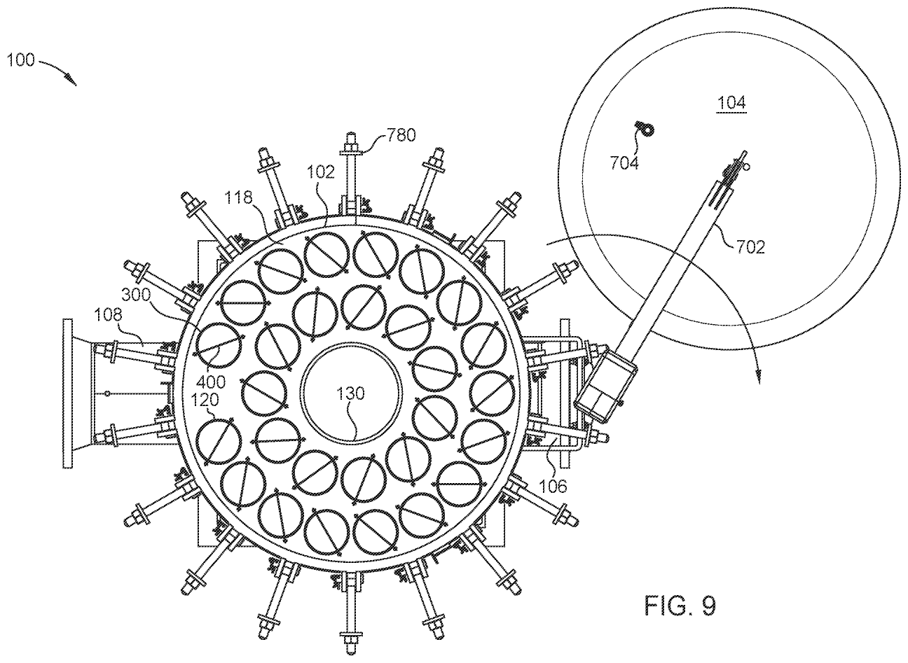

The lid 104 is lifted from the body 102 by the crane 700. The crane 700 is coupled to the body 102 of the fluid strainer 100 by a bracket 714. The crane 700 includes a stanchion 712, a crane arm 702 and a winch 708. The stanchion 712 is connected to the bracket 714 by a rotary joint 710. The rotary joint 710 allows the stanchion 712 to rotate on a vertical axis (Y-axis). The end of the stanchion 712 opposite the rotary joint 710 is coupled to the crane arm 702. The crane arm 702 is sufficiently long enough to extend over the center region of the lid 702. The end of the crane arm 702 oppose the stanchion 712 includes a pulley 716. A lift cable 718 is coupled to a lifting flange 720 of the lid 104 and extend through the pulley 716 to the winch 708. The winch 708 may be manual or powered. In one example, the winch 708 is hydraulic or electric powered. The winch 708 may be operated to lift and lower the lid 104 off of or on to the body 102. Once the winch 708 has lifted the lid 104 clear of the body 102, the arm 702 and lid 104 supported therefrom may be rotated via the rotary joint 710 clear of the body 102 as shown in FIG. 9, allowing access to the upper chamber 126 such that the filter bags 400 may be replaced.

The drawing figures illustrate architecture, functionality, and operation of possible implementations of systems and methods according to various examples of a strainer. While the foregoing is directed to specific examples, other and further examples may be devised without departing from the basic scope thereof, and the scope thereof is determined by the claims that follow.

What is claimed is:

1. A fluid strainer, comprising:
a body and a lid, wherein inner surfaces of walls of the body and lid define a cavity therein, and wherein the wall of the body has a fluid inlet opening and a fluid outlet opening;
a tube sheet disposed within the cavity, wherein the tube sheet divides the cavity into first and second chambers, and wherein the tube sheet has a plurality of filter openings and a fluid inlet, the fluid inlet open to the first chamber;
a plurality of filter retaining baskets, each filter retaining basket disposed in a respective one of the filter openings;
a plurality of filter retainers, each filter retainer configured to removably attach to the tube sheet and extend into a respective one of the filter retaining baskets; and
an internal fluid inlet pipe disposed within the second chamber and coupling the fluid inlet opening to the fluid inlet opening of the tube sheet.

2. The fluid strainer of claim 1, wherein the fluid outlet opening does not have filter retaining basket directly adjacent the fluid outlet opening.

3. The fluid strainer of claim 1, wherein the plurality of filter openings are arranged in two concentric rows.

4. The fluid strainer of claim 3, wherein an inner row of the two concentric rows have filter openings that are equally spaced.

5. The fluid strainer of claim 4, wherein an outer row of the two concentric rows have filter openings that are arranged in a C-shaped pattern.

6. The fluid strainer of claim 1 further comprising:
two concentric seals each sealingly contacting the lid and the body.

7. The fluid strainer of claim 6, wherein the concentric seals each have four lobes.

8. The fluid strainer of claim 1, wherein the filter retainer comprises a spring wire form.

9. The fluid strainer of claim 1, wherein the filter retainer comprises:
a first end coupled to a first cross member section, the first cross member section coupled to a first clamp member section;
a second end coupled to a second cross member section, the second cross member section coupled to a second clamp member section, the second clamp member section dispose parallel to the first clamp member section; and
a connecting section coupling the first and second clamp member sections.

10. The fluid strainer of claim 9, wherein the filter retainer has sufficient spring force to urge the first and second clamp member sections against opposite sides of the filter retaining basket.

11. The fluid strainer of claim 1, wherein the first and second clamp member sections and first and second cross member sections extend into the filter retaining basket when the first and second ends of the filter retainer are engage with a retainer mounted to the tube sheet.

12. A fluid strainer, comprising:
a body and a lid, wherein inner surfaces of walls of the body and lid define a cavity therein, and wherein the wall of the body has a fluid inlet opening and a fluid outlet opening;
two concentric seals each sealingly contacting the lid and the body;
a tube sheet disposed within the cavity, wherein the tube sheet divides the cavity into first and second chambers, and wherein the tube sheet has a plurality of filter openings and a fluid inlet, the fluid inlet open to the first chamber;
a plurality of filter retaining baskets, each filter retaining basket disposed in a respective one of the filter openings, wherein a spacing between the filter retaining baskets disposed directly in front of the fluid outlet opening is greater than spacing between the filter retaining baskets disposed on an opposite side of the body relative to the fluid outlet opening;
a plurality of filter retainers, each filter retainer configured to removably attach to the tube sheet and extend into a respective one of the filter retaining baskets; and
an internal fluid inlet pipe disposed within the second chamber and coupling the fluid inlet opening to the fluid inlet opening of the tube sheet.

13. The fluid strainer of claim 12, wherein the plurality of filter openings are arranged in two concentric rows.

14. The fluid strainer of claim 13, wherein an inner row of the two concentric rows have filter openings that are equally spaced.

15. The fluid strainer of claim 14, wherein an outer row of the two concentric rows have filter openings that are arranged in a C-shaped pattern.

16. The fluid strainer of claim 15, wherein the concentric seals each have four lobes.

17. The fluid strainer of claim 12, wherein the filter retainer comprises a spring wire form, and wherein the filter retainer further comprises:
a first end coupled to a first cross member section, the first cross member section coupled to a first clamp member section;
a second end coupled to a second cross member section, the second cross member section coupled to a second clamp member section, the second clamp member section dispose parallel to the first clamp member section; and
a connecting section coupling the first and second clamp member sections.

18. The fluid strainer of claim 17, wherein the filter retainer has sufficient spring force to urge the first and second clamp member sections against opposite sides of the filter retaining basket.

19. A fluid strainer, comprising:
a body and a lid, wherein inner surfaces of walls of the body and lid define a cavity therein, and wherein the wall of the body has a fluid inlet opening and a fluid outlet opening;
two concentric seals each sealingly contacting the lid and the body;
a tube sheet disposed within the cavity, wherein the tube sheet divides the cavity into first and second chambers, and wherein the tube sheet has a plurality of filter openings and a fluid inlet, the fluid inlet open to the first chamber, the filter openings are arranged in an inner row of equally spaced filter openings and an outer row of filter openings arranged in a C-shaped pattern;
28 filter retaining baskets, each filter retaining basket disposed in a respective one of the filter openings, wherein a spacing between the filter retaining baskets disposed directly in front of the fluid outlet opening is greater than spacing between the filter retaining baskets disposed on an opposite side of the body relative to the fluid outlet opening;
28 of filter retainers, each filter retainer configured to removably attach to the tube sheet and extend into a respective one of the filter retaining baskets, the filter retainers configured to retain bag filters within the filter retaining baskets, the filter retainers having sufficient spring force to urge sections of the filter retainer against opposite sides of the filter retaining basket; and
an internal fluid inlet pipe disposed within the second chamber and coupling the fluid inlet opening to the fluid inlet opening of the tube sheet.

20. The fluid strainer of claim 19, wherein the filter retainer comprises a spring wire form, and wherein the filter retainer further comprises:
a first end coupled to a first cross member section, the first cross member section coupled to a first clamp member section;
a second end coupled to a second cross member section, the second cross member section coupled to a second clamp member section, the second clamp member section dispose parallel to the first clamp member section; and
a connecting section coupling the first and second clamp member sections.
